(19) United States
(12) Patent Application Publication
(10) Pub. No.: US 2017/0126019 A1
(43) Pub. Date: May 4, 2017

(54) SYSTEMS AND METHODS FOR REDUNDANT POWER SUPPLY

(71) Applicant: Salt River Project Agricultural Improvement and Power District, Phoenix, AZ (US)

(72) Inventors: Clinton T. Poole, Scottsdale, AZ (US); Devin C. Warren, Gilbert, AZ (US)

(21) Appl. No.: 15/338,004

(22) Filed: Oct. 28, 2016

Related U.S. Application Data
(60) Provisional application No. 62/250,504, filed on Nov. 4, 2015.

(51) Int. Cl. H02J 5/00

(52) U.S. Cl. CPC H02J 5/00

(57) ABSTRACT

Systems and methods for redundant power supply may operate in conjunction with an electrical grid having multiple electrically independent subsections and/or substations. A first power distribution path from a first subsection of the electrical grid is electrically independent from a second power distribution path from a second subsection of the electrical grid, and the power distribution paths may originate from electrically independent subsections of the electrical grid. The first and second power distribution paths may be provided to a structure.

### CROSS-REFERENCES TO RELATED APPLICATIONS

This application claims the benefit of U.S. Provisional Patent Application No. 62/250,504, filed Nov. 4, 2015, and incorporates the disclosure of the application by reference.

### BACKGROUND

Many systems require reliable electric power. Power interruptions can be extremely costly, especially to commercial-industrial consumers, and may even lead to hazardous conditions. Vital loads require constant power availability and cannot be interrupted, even momentarily.

Data centers in particular require reliable power. References to data center availability often refer to a tiered system with four tier levels. A tier-4 data center may include fault-tolerant site infrastructure with electrical power storage and distribution facilities with expected availability of 99.995%. Any power loss costs availability not only for the duration of the outage, but for the time required to reboot the computer server, recover data, and repair corrupted data, which could be minutes, hours or days.

Referring to FIG. 1A, traditional data centers and other electric facilities receive power from the grid provided by a local utility. The data center may be configured to receive two power paths from a utility company; however, only one of the two power paths is configured to be operable at any given time (the non-operable power path may be configured as a backup power path in case of emergencies). A transfer switch may be utilized to switch between the two power paths such that power is supplied by one or the other. Switching between the two power paths is a manual process, and may require a brief downtime in power availability. Thus, to enhance reliability, some systems use backup power sources, such as backup generators, transfer switches, power distribution units (PDUs) and uninterruptible power supplies (UPSs). But these systems can be costly, complex, and ineffective. For example, independent power sources that are connected to an automatic transfer switch can switch to a backup supply if the primary supply fails. But many such switches operate only after a delay that cannot be tolerated by the servers. Further, a UPS or generator may provide backup power, but a server array may draw a great deal of power, so high capacity UPSs and powerful generators are required, even when the backup systems are expected to operate for only a few seconds.

### SUMMARY

Systems and methods for redundant power supply may operate in conjunction with an electrical grid having multiple electrically independent subsections and/or substations. A first power distribution path from a first subsection of the electrical grid is electrically independent from a second power distribution path from a second subsection of the electrical grid, and the power distribution paths may originate from electrically independent subsections of the electrical grid. The first and second power distribution paths may be provided to a structure.

### BRIEF DESCRIPTION OF THE DRAWINGS

A more complete understanding of the present technology may be derived by referring to the detailed description when considered in connection with the following illustrative figures. Throughout the following figures, like reference numbers refer to similar elements and steps.

FIG. 1A is a block diagram of a traditional power provision scheme;

FIG. 1B is a block diagram of an electrical power distribution network according to various aspects of the present invention;

FIG. 1C is an alternative block diagram of the electrical power distribution network according to various aspects of the present technology

FIG. 2 is a block diagram of an exemplary embodiment of a substation utilized within the electrical power distribution network;

FIG. 3 is a block diagram of an exemplary embodiment of a portion of a transmission network within the electrical power distribution network; and

FIG. 4 is a block diagram of an exemplary embodiment of a structure according to various aspects of the present invention configured to receive two electrically independent power distribution paths.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various types of substations, generators, transformers, switches, bus-bars, transmission lines, and the like, which may carry out a variety of functions. In addition, the present technology may be practiced in conjunction with any number of systems for providing electrical power, and the system described is merely one exemplary application for the technology. Further, the present technology may employ any number of conventional techniques for transmitting, receiving, and modifying electrical power.

System and methods for redundant power supply according to various aspects of the present technology may operate in conjunction with any suitable electrical network, such as a conventional power grid system. Various representative implementations of the present technology may be applied to any appropriate system or environment consuming electric power.

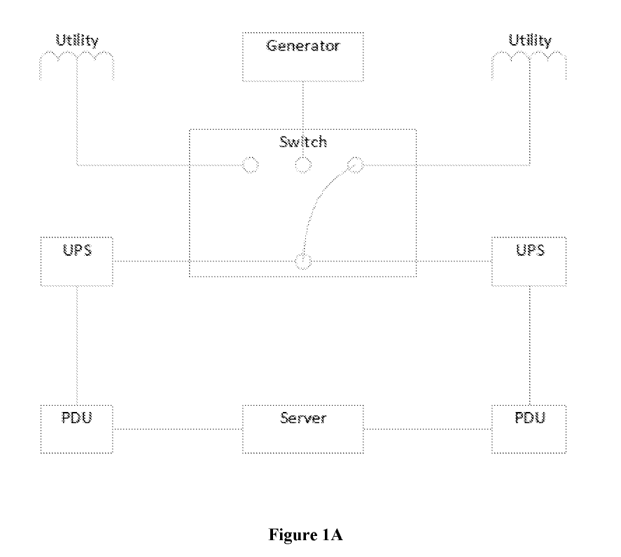

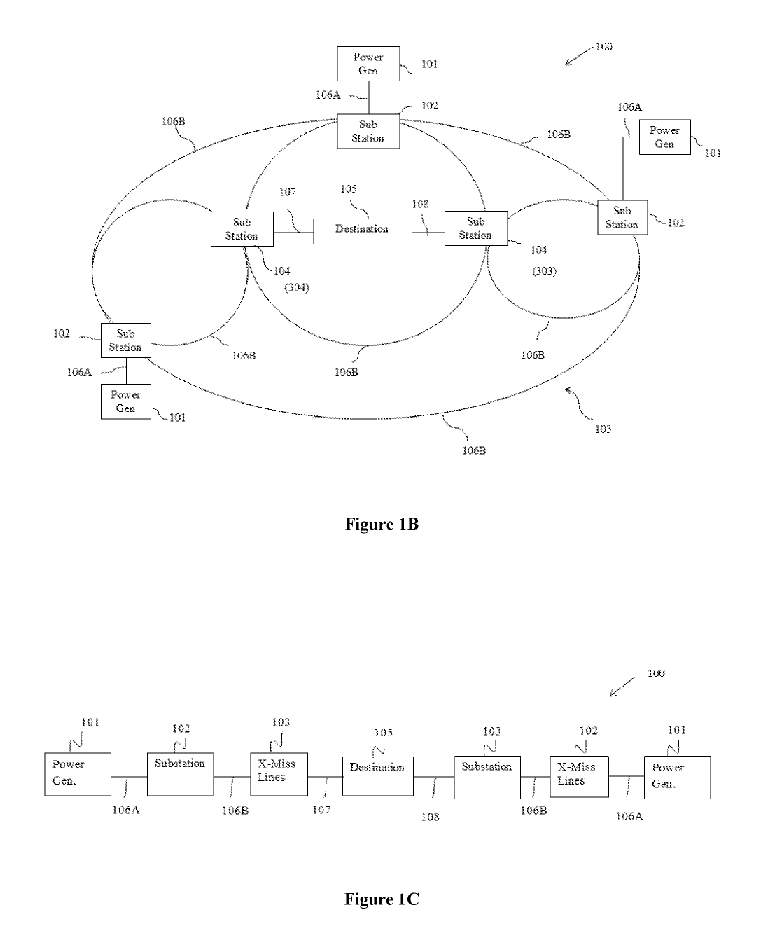

Referring now to FIGS. 1B-C and 3, systems and methods for redundant power supply may operate in conjunction with an electrical power distribution network 100. The electrical power distribution network 100 may comprise, for example, one or more power generation stations 101, one or more power supply substations 102, 104, 303, 304 a transmission network 103, and a destination 105 electrically coupled to the electrical power distribution network 100. The power generation stations 101 may generate electrical power, and may comprise any suitable source of electrical power, such as a conventional hydroelectric, fossil fuel, nuclear, wind, solar, marine, biomass, storage, geothermal, or other type of generator, power plant, or power source. In various embodiments, the systems and methods for redundant power supply may operate in conjunction with multiple independent power generation stations 101.

Generated electrical power 106A may flow from a power generation station 101 to one or more substations 102, 104, via the transmission network 103 and finally to the destination 105. Electric power may flow through several substations between the power generating plant 101 and the destination 105 as shown in FIGS. 1B-C. The substations may comprise various components for particular functions, such as transformers, switching equipment, protection equipment, and/or control equipment.

The various substations may step up voltages (from a lower voltage to a higher voltage) or step down voltages (from a higher voltage to a lower voltage). For example, a power generation station 101 may be configured to generate electricity at low voltages, and the low voltage power 106A may be transmitted to a first substation 102 wherein the low voltage may be transformed to a high voltage (or vice versa).

Substations 102, 104, 303, 304 may comprise any suitable system or device for the transmission and/or distribution of electrical power. The various substations may comprise transmission substations, distribution substations, collector substations, converter substations, frequency-changing substations, switching substations, and/or the like. In one embodiment, a transmission substation may electrically couple two or more transmission lines within the transmission network 103. The transmission substation may comprise high-voltage switches which may be electrically coupled or isolated, such as for fault clearance or maintenance. A transmission substation may comprise transformers configured to convert between two transmission voltages (e.g., from a low voltage transmission into a high voltage transmission and vice versa).

A distribution substation may transfer electrical power from a transmission system to a distribution system for an area. For example, it may be uneconomical in some situations to directly connect electricity consumers to the main transmission network. In these situations, the distribution station may reduce the voltage to a level suitable for distribution. The distribution substation may comprise multiple inputs and outputs. The inputs may comprise transmission lines carrying an input voltage, and the outputs may comprise transmission lines carrying an output voltage configured for particular applications. In addition, the distribution substation may isolate faults in either the transmission or distribution systems. For example, the distribution substation may isolate faults in the transmission network 103 and/or faults within the substations 102, 104, 303, 304.

A collector substation may operate with the electrical power distribution network 100 to add power to the power grid via the transmission lines. For example, in some distributed power generation schemes (e.g., a wind farm), a collector substation may facilitate the transfer of electrical power from the wind farm to the transmission network 103.

A switching substation may operate at a single voltage level and connect and disconnect various transmission lines within the transmission network 103. For example, if certain lines need to be deactivated for maintenance, the switching substation may switch the transmission lines to deactivate the relevant lines.

In the present exemplary embodiment, the various substations 102, 104, 303, 304 may comprise conventional substations, for example where electricity is transformed and/or regulated for long-distance transmission (high voltage) and for local distribution (low voltage). For example, a first substation 102 may step up the voltage received from a power generation station 101, such as increasing the voltage for long-distance transmission, and a second substation 104 may step down the voltage received via the transmission network 103, such as decreasing the voltage for distribution and use by the destination 105.

For example, a substation 102 of the present embodiment may transform the voltage of the generated electrical power from a first voltage to a second voltage, such as from a low voltage to a high voltage. The first substation 102 may step up the voltage to high voltages for long-distance transmission on the transmission grid, such as in the range of 150,000 to 775,000 volts. Higher transmission voltages inhibit energy loss due to resistance. Multiple substations 102 may be utilized, for example to provide power to different transmission networks 103 and destinations 105. The transformed generated power may be transmitted from the first substation 102, via the transmission network 103, to a second substation 104, as well as to other substations.

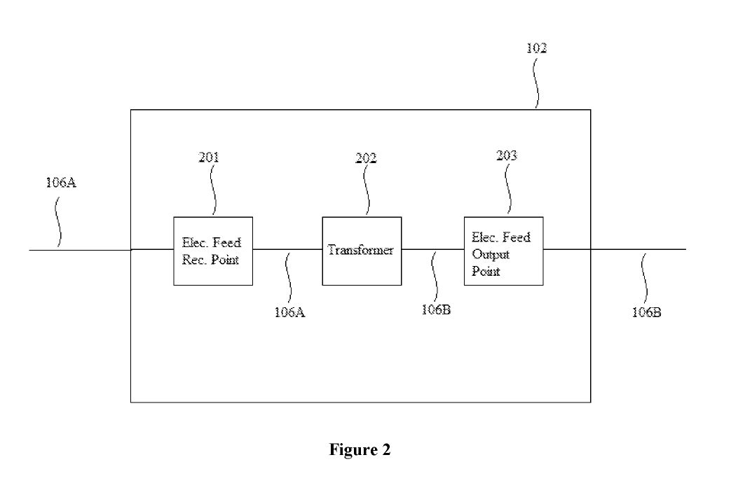

Referring to FIG. 2, an embodiment of a substation 102 may comprise an electrical feed receiving point 201. The electrical feed receiving point 201 may comprise any suitable system or device to receive incoming electrical power 106A, directly or indirectly, from a power generation station 101, such as a conventional conductive connection. The electrical feed receiving point 201 may provide the incoming electrical power 106A to a step-up transformer 202.

The step-up transformer 202 steps up the voltage level of the received electrical power 106A. For example, the step-up transformer 202 may transform the electrical power 106A from a low-voltage to a high-voltage before providing the high-voltage electrical power 106B to an electrical feed output point 203. The transformer 202 may comprise any suitable system or device for stepping up voltages, such as a conventional step-up transformer used in power distribution.

The electrical feed output point 203 receives electrical power 106B and provides the electrical power 106B to the transmission network 103. For example, the electrical feed output point 203 may provide the stepped-up electrical power 106B from the transformer 202 to the transmission network 103, and may comprise any suitable system or device for transmitting the power, such as a conventional conductive connection.

Now referring to FIGS. 1-3, the transmission network 103 may comprise any suitable system or device to facilitate the transmission of electrical power from a source to destinations 105 over substantial distances, such as at least a few meters or kilometers to hundreds of kilometers. For example, the transmission network 103 may comprise the network colloquially referred to as “the grid” (or “the electrical grid” or “the power grid”) and its associated structure and components.

In one embodiment, the transmission network 103 may facilitate transmission of electric power comprising a variety of voltages and/or currents. The transmission network 103 may facilitate the transfer of low (e.g., less than 1000v), medium (e.g., between 1-kV and 69-kV), high (e.g., 115-kV and 138-kV), extra high (e.g., 230-kV-800-kV), and/or ultra-high voltages (e.g., voltages exceeding 800-kV). The transmission network 103 may transmit alternating current (AC) and/or direct current (DC). In one embodiment, the transmission network 103 may operate in conjunction with additional equipment, devices, and/or components. For example, the transmission network 103 may operate in conjunction with any number of substations, switches, relays, converters, transformers, and/or the like.

The exemplary transmission network 103 of the present embodiment may comprise multiple subsections 301, 302, wherein the individual subsections 301, 302 within the transmission network 103 comprise electrically independent nodes/sections. For example, the transmission network 103 may facilitate transmission of electric power across a 50-mile radius. The 50-mile radius may include multiple subsections 301, 302, and each individual subsection 301, 302 may be electrically independent from each other individual subsection 301, 302. “Electrically independent” or simply “independent” refers to operational isolation from other subsections such that a failure or defect within a subsection 301 does not substantially affect the ability of an electrically independent subsection 302 to provide power. Thus, if there is an electrical power outage within one subsection 301, 302 of the transmission network 103, for example due to a blown transformer or a downed power line, the remaining electrically independent subsections 301, 302 continue to operate normally.

In one embodiment, each of the independent subsections 301, 302 within the transmission network 103 may comprise multiple electrically independent power supply substations 303, 304. The independent substations 303, 304 may each provide electrical power to a geographical coverage area and/or within a predetermined subsection 301, 302 of the electrical grid. Each independent substation 303, 304 may receive electrical power via the transmission network 103 from the same power generation station 101 or different sources. For example, a first independent substation 303 located in a first geographical coverage area may receive its electrical power from a first power generation station 101. A second independent substation 304 located in a second geographical coverage area may receive its electrical power from the same first power generation station 101 and/or from a different power generation station or power source. Despite receiving electrical power from the same power generation station 101, each of the independent substations 303, 304 and its geographical coverage area may be electrically independent from the others. An outage or disturbance at the first independent substation 303 would not negatively affect the operation of second independent substation 304 (or vice versa).

Multiple power distribution paths 107, 108 (also referred to as “active feeds”) may be derived from the transmission network 103 and/or the substations 102, 104, 303, 304. An active feed/power distribution path 107, 108 may comprise any suitable system or device configured to provide an electrical power distribution path from a first point to a second point. For example, referring again to FIGS. 1B and 1C, a power distribution path 107 may comprise the electrical power distribution path from the power generation station 101 to the first substation 102, then from the first substation 102 to a second substation 104, and from the second substation 104 to the destination 105.

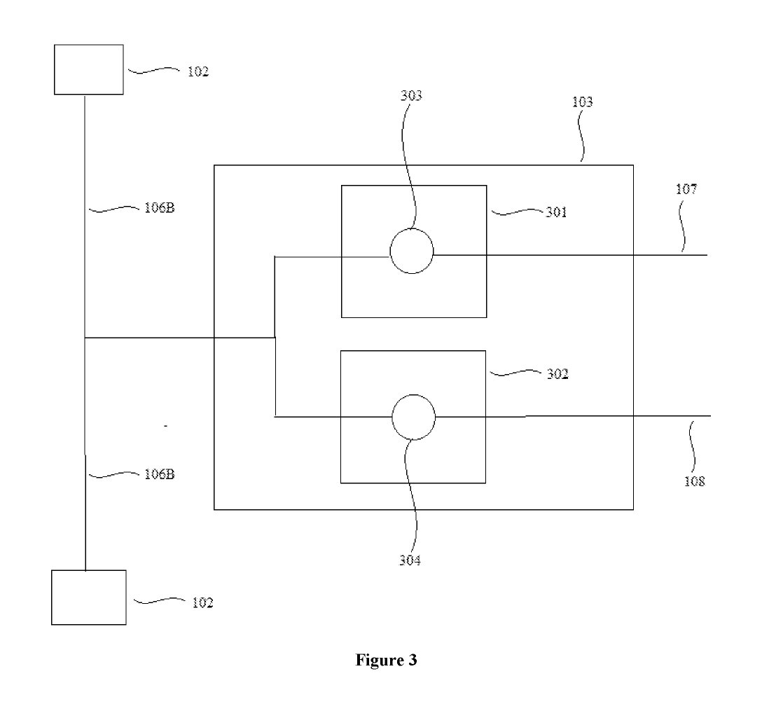

Referring again to FIG. 3, the transmission network 103 may include two separate electrical power distribution paths 107, 108 from two electrically independent substations 303, 304 within the transmission network 103. For example, one power distribution path 107 may comprise an active feed from a first electrically independent substation 303 of the transmission network 103, and another power distribution path 108 may comprise an active feed from a second electrically independent substation 304 of the transmission network 103. The power distribution paths 107, 108 may originate from a common electrical power path 106B, but the electrical power path 106B may be provided to two electrically independent subsections 301, 302 such that failure and/or outage at one subsection 301 would not affect the operation of the second subsection 302 (and their respective substations 303, 304).

In one embodiment, the power distribution paths 107, 108 may be configured to provide electrical power to any system or device configured to receive electric power. The power distribution paths 107, 108 may comprise any of the above-mentioned low, medium, high, extra-high, and/or ultra-high voltages or power exhibiting other appropriate characteristics.

Systems and methods for redundant power supply according to various aspects of the present invention provide at least two independent active feeds to the destination 105. For example, referring again to FIG. 1, a substation 102, 104, 303, 304 may provide two electrically independent active feeds to the destination 105 from the same transmission network 103 or from different transmission networks or other sources. In the present embodiment, a first power distribution path 107 may be electrically coupled to a first subsection 301 of the transmission network 103, and a second power distribution path 108 may be electrically coupled to a second subsection 302 of the transmission network 103, wherein the first subsection 301 and the second subsection 302 comprise two electrically independent subsections of the transmission network 103.

A substation 102, 104, 303, 304 of the present embodiment may perform additional functions, such as to transform the voltage of the generated electrical power from one voltage to another. For example, a substation 102, 104, 303, 304 may transform the generated power from a high voltage into a low voltage for distribution. Multiple substations 102, 104, 303, 305 may be utilized, for example to provide power from different transmission networks 103 and/or electrically independent subsections 301, 302 to the destination 105, as well as to other destinations 105. Thus, a single substation 102, 104, 303, 304 may provide multiple independent active feeds to the destination 105, or multiple substations 102, 104, 303, 304 may each provide one or more independent active feeds to the destination 105.

The destination 105 may receive power via multiple electrically independent power distribution paths 107, 108. For example, a substation 102, 104, 303, 304 may provide the first power distribution path 107 and the second power distribution path 108 to the destination 105. The destination 105 may be configured with any suitable system or device to receive two independent power distribution paths 107, 108, and may comprise additional components to distribute the power distribution paths 107, 108 to various components disposed at and/or within the destination 105.

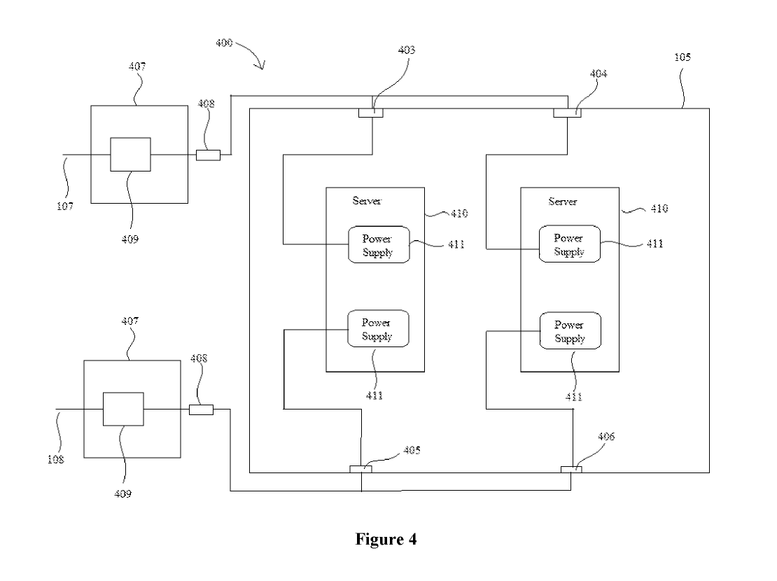

For example, referring to FIG. 4, the destination 105 may include receiving points (not shown) to receive power. The receiving points may be electrically independent such that power delivered via one receiving point is not affected by a loss of power or defect via another receiving point, and vice versa. In one embodiment, one of the multiple power distribution paths 107, 108 may be electrically coupled to each of the individual receiving points 401, 402 disposed within (or proximate to) the destination 105.

The destination 105 may comprise any structure or system configured to utilize electric power and/or provide electric power to electrical systems, such as machinery and/or electronic components like computers or digital storage systems. For example, in one embodiment, the destination 105 may comprise a computer center housing one or more computers, such as a data center 400 housing one or more servers 410. Each server 410 may comprise at least one power supply unit (PSU) 411; in the present embodiment, each server is equipped with at least two PSUs. The PSUs 411 may comprise conventional PSUs, for example to convert mains AC to low-voltage regulated DC power for the internal components of the server. The PSUs may provide additional functions as well, such as short circuit protection, overload protection, overvoltage protection, under voltage protection, overcurrent protection, and over temperature protection.

Each server 410 may receive two separate power distribution paths 107, 108 such that one PSU receives power from one of the power distribution paths 107 and the other PSU 411 receives power from the other electrically independent power distribution path 108. Thus, if one of the power distribution paths 107 suffers an outage and/or is otherwise unable to provide electrical power, the other power supply 411 may still continue to operate using power from the remaining power distribution path 108.

In one embodiment, the structure comprises a modular structure dedicated to housing and operating computers and associated systems. For example, the structure may comprise a modular data center including a standardized housing equipped with standardized power and cooling systems. The structure may be portable, such as by using a standard shipping container as a housing. The structure may also comprise prefabricated components to be assembled at a site.

The destination 105 may be configured in any suitable manner to connect the electrically independent power distribution paths 107, 108 to the electrically powered equipment. For example, the servers 410 or other electronic components may be electrically coupled to one or more electrically independent structural distribution systems. The structural distribution systems may comprise any appropriate systems for distributing power to the relevant electric devices associated with the destination 105.

For example, the structural distribution systems at the destination 105 may comprise electrical connections 403, 404, 405, 406 disposed within the exemplary data center 400. An electrical connection may comprise any suitable system or device configured to receive electrical power from a first source and provide the received electrical power to a second source. For example, an electrical connection may comprise a bus bar, power strip, electrical sockets, and/or the like. Each electrical connection 403, 404, 405, 406 may receive electric power from at least one of the power distribution paths 107, 108. For example, half the electrical connections 403, 404 may be electrically coupled to the first power distribution path 107 originating from the first electrically independent subsection 301, and the other half of the electrical connections 405, 406 may be electrically coupled to the second power distribution path 108 originating from the second electrically independent subsection 302 of the transmission network 103. Thus, if the first or second power distribution path 107, 108 originating from the first or second electrically independent subsection 301, 302 of the electric grid becomes deficient or inoperable, the remaining power distribution path may continue to provide electric power to all of the servers 410 via the other half of the electrical connections 403, 404, 405, 406.

In one embodiment, the power distribution paths 107, 108 may be provided to the data center 400 via a distribution system including one or more service entrance sections 407. The service entrance section 407 may comprise equipment useful at the point where electrical service enters a structure and/or equipment related to the point of entry for electrical service. The service entrance section 407 may comprise any suitable system or device configured to receive one or more power distribution paths 107, 108 and facilitate the transfer of electric power from the power distribution paths 107, 108 to the destination 105. For example, the service entrance section 407 may comprise circuit breakers, switches, fuses, electric bus-bars 408, meters and/or the like. In a modular environment, the service entrance section 407 may be fixed to and/or integrated into the modular structure. In one embodiment, the destination includes at least two service entrance sections 407, wherein each independent power distribution path 107, 108 is connected only to a dedicated service entrance section 407, and each service entrance section 407 is electrically independent from the other service entrance sections 407.

In one embodiment, the service entrance section 407 may comprise or be connected to a step-down transformer 409. The step-down transformer 409 may comprise any suitable system or device configured to step down the received voltage from a high voltage to a lower voltage to be used by the systems powered by the electricity. For example, the step-down transformer 409 may be electrically coupled to one of the power distribution paths 107, 108 and facilitate the transformation and transfer of power to the electrical connections 403, 404, 405, 406. If the voltage level of the power distribution path 107, 108 is too high for the electrical connection 403, 404, 405, 406, the step-down transformer 409 reduces the voltage to a suitable level.

In one embodiment, the destination includes at least two step-down transformers 409, wherein each independent power distribution path 107, 108 is connected only to a dedicated step-down transformer 409, and each step-down transformer 409 is electrically independent from the other step-down transformers 409.

The destination's 105 distribution system may include the bus-bars 408 to transfer substantial electric power over relatively short distances, such as within a few meters, and may comprise any suitable system or device, such as a conventional bus-bar for conducting electricity in a switchboard, distribution board, substation, battery bank, or other electrical system. For example, the bus-bar 408 may receive the stepped-down power from the step-down transformer 409 and transfer the stepped-down power to the servers 410 electrically coupled to the bus-bar 408 via the connections 403, 404, 405, 406. Each bus-bar 408 may receive an electrically independent stepped-down (or non-stepped) power distribution path 107, 108. The electrically independent power distribution path 107, 108 may comprise a power distribution path originating from an electrically independent subsection 301, 302 of the transmission network 103.

In operation, the power generating stations 101 generates power, which is supplied to the transmission network 103. The supplied power may be processed in any suitable manner, such as to transform voltages or filter transients. For example, the first substation 102 may step up the voltage for long-distance transmission, and the second substation 104 may step down the voltage for distribution near the destination 105. The transmission network 103 transmits the power to multiple electrically independent subsections 301, 302 and/or via multiple electrically independent power distribution paths 107, 108.

The destination 105 receives power from at least two electrically independent subsections 301, 302 and/or via at least two electrically independent power distribution paths 107, 108. Electric equipment at the destination 105 receives power from two electrically independent distribution paths via electrically independent distribution systems. In one embodiment, the electric equipment includes the servers 410, each of which includes at least two PSUs 411. Each PSU 411 in a particular server 410 receives power from a different electrically independent distribution path 107, 108 and/or electrically independent subsection 301, 302. Additional power processing may be performed at or near the destination 105. For example, the received power may be transformed to suitable voltages and/or distributed to various connections or other access points, such as via the bus-bars 408 and service entrance sections 407.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

In the foregoing specification, the invention has been described with reference to specific exemplary embodiments. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. A modular data center configured to receive electrical power from an electrical grid having a plurality of external electrically independent electrical feeds from electrically independent subsections of the electrical grid, comprising:
a structure coupled to the plurality of external electrical feeds;
a power distribution system coupled to the first structure, wherein the power distribution system provides the plurality of external electrical feeds to a plurality of electronic components housed within the structure, the power distribution system comprising:
a first power distribution path; and
a second power distribution path, wherein the first power distribution path and the second power distribution path originate from electrically independent subsections of the electrical grid.

2. The modular data center of claim 1, further comprising:
a first transformer connected between a first external electrical feed and the first power distribution path; and
a second transformer connected between a second external electrical feed and the second power distribution path, wherein the second transformer is electrically independent from the first transformer.

3. The modular data center of claim 2, wherein the first transformer comprises a step-down transformer and second transformer comprises a step-down transformer.

4. The modular data center of claim 1, wherein the power distribution system further comprises:
a first electric bus-bar coupled to the structure and electrically coupled to first power distribution path; and
a second electric bus-bar coupled to the structure and electrically coupled to the second power distribution path, wherein the second electric bus-bar is electrically independent from the first electric bus-bar.

5. The modular data center of claim 4, wherein:
the first electric bus-bar electrically couples the first power distribution path to the plurality of electronic components housed within the structure; and
the second electric bus-bar electrically couples the second power distribution path to the plurality of electronic components housed within the structure.

6. The modular data center of claim 1, wherein the power distribution system further comprises:
a first service entrance section electrically coupled to the first power distribution path; and
a second service entrance section electrically coupled to the second power distribution path, wherein the second service entrance section is electrically independent from the first service entrance section.

7. The modular data center of claim 1, wherein the power distribution system further comprises:
a first connection electrically coupled to the first power distribution path; and
a second connection electrically coupled to the second power distribution path, wherein the second connection is electrically independent from the first connection.

8. The modular data center of claim 1, wherein the electronic components housed within the structure comprises a plurality of computer servers.

9. The modular data center of claim 8, wherein each computer server comprises;
a first power supply unit connected to the first power distribution path; and
a second power supply unit connected to the second power distribution path.

10. A computer center receiving electrical power from a power grid comprising at least a first electrically independent subsection and a second electrically independent subsection, the computer center comprising:
a computer comprising a first power supply unit and a second power supply unit;
a first electrical connection, wherein the first power supply unit is electrically coupled to the first electrical connection;
a second electrical connection, wherein the second power supply unit is electrically coupled to the second electrical connection;
a first power distribution path electrically coupled to the first electrical connection, wherein the first power distribution path delivers electric power from the first electrically independent subsection to the first electrical connection; and
a second power supply line electrically coupled to the second electrical connection, wherein the second power distribution path delivers electric power from the second electrically independent subsection to the second electrical connection.

11. The computer center of claim 10, further comprising:
a first transformer connected between the first electrically independent subsection and the first electrical connection; and
a second transformer connected between the second electrically independent subsection and the second electrical connection, wherein the second transformer is electrically independent from the first transformer.

12. The computer center of claim 11, wherein the first transformer comprises a step-down transformer and second transformer comprises a step-down transformer.

13. The computer center of claim 10, further comprising:
a first electric bus-bar coupled to the structure and electrically coupled between the first electrically independent subsection and the first electrical connection; and
a second electric bus-bar coupled to the structure and electrically coupled between the second electrically independent subsection and the second electrical connection, wherein the second electric bus-bar is electrically independent from the first electric bus-bar.

14. The computer center of claim 10, further comprising:
a first service entrance section electrically coupled between the first electrically independent subsection and the first electrical connection; and
a second service entrance section coupled to the structure and electrically coupled between the second electrically independent subsection and the second electrical connection, wherein the second service entrance section is electrically independent from the first service entrance section.

15. The computer center of claim 10, further comprising a structure coupled to the first power distribution path and the second power distribution path and housing the computer.

16. The computer center of claim 15, wherein the structure comprises a modular data center structure.

17. A power supply system for a structure, comprising:
a first power supply substation;
a second power supply substation, wherein the second power supply substation is electrically independent from the first power supply substation;
a first power distribution path proximate the structure and configured to be electrically coupled to the structure, wherein the first power distribution path is configured to provide electrical power from the first power supply station to the structure; and
a second power distribution path proximate the structure and configured to be electrically coupled to the structure, wherein:
the second power distribution path is configured to provide electrical power from the second power supply station to the structure; and
the second power distribution path is electrically independent from the first power distribution path at the structure.

18. The power supply system of claim 17, further comprising:
a first transformer connected between the first power supply substation and the first power distribution path; and
a second transformer connected between the second power supply substation and the second power distribution path, wherein the second transformer is electrically independent from the first transformer.

19. The power supply system of claim 18, wherein the first transformer comprises a step-down transformer and second transformer comprises a step-down transformer.

20. A method of providing at least two active electrical feeds to a structure from an electrical grid having multiple electrically independent subsections, the method comprising:
receiving a first power distribution path from a first subsection of the electrical grid;
receiving a second power distribution path from a second subsection of the electrical grid, wherein the first power distribution path and the second power distribution path originate from electrically independent subsections of the electrical grid;
providing the first power distribution path to a first distribution system of the structure; and
providing the second power distribution path to a second distribution system of the structure, wherein the second distribution system is electrically independent from the first distribution system.

21. The method of claim 20, further comprising:
electrically coupling a first electric bus-bar to the first power distribution path; and
electrically coupling a second electric bus-bar to the second power distribution path, wherein the second electric bus-bar is electrically independent from the first electric bus-bar.

22. The method of claim 21, further comprising:
electrically coupling the first electric bus-bar between the first power distribution path and a plurality of electronic components disposed within the structure; and
electrically coupling the second electric bus-bar between the second power distribution path and the plurality of electronic components.

23. The method of claim 20, further comprising:
electrically coupling the first power distribution path to a first service entrance section coupled to the structure; and
electrically coupling the second power distribution path to a second service entrance section coupled to the structure.

24. The method of claim 20, further comprising:
electrically coupling the first power distribution path to a first connection coupled to the structure; and
electrically coupling the second power distribution path to a second connection coupled to the structure, wherein the second connection is electrically independent from the first connection.

25. The method of claim 20, further comprising:
electrically coupling the first power distribution path to a computer; and
electrically coupling the second power distribution path to the computer.

26. The method of claim 25, wherein:
the computer server comprises a first power supply unit and a second power supply unit;
electrically coupling the first power distribution path to the computer comprises electrically coupling the first power distribution path to the first power supply unit; and
electrically coupling the second power distribution path to the computer comprises electrically coupling the second power distribution path to the second power supply unit.

27. The method of claim 20, wherein the structure comprises a modular data center structure.
